(19) United States
(12) Patent Application Publication
(10) Pub. No.: US 2018/0059437 A1
(43) Pub. Date: Mar. 1, 2018

(54) PLASTIC OPTICAL MEMBER

(71) Applicant: HOYA LENS THAILAND LTD., Prachatipat, Thanyaburi, Patumthani (TH)

(72) Inventors: Masahisa KOUSAKA, Tokyo (JP); Natsumi TASAKI, Tokyo (JP)

(73) Assignee: HOYA LENS THAILAND LTD., Prachatipat, Thanyaburi, Patumthani (TH)

(21) Appl. No.: 15/557,281

(22) PCT Filed: Mar. 11, 2016
(86) PCT No.: PCT/JP2016/057809

§ 371 Date: Sep. 11, 2017

(30) Foreign Application Priority Data
Mar. 11, 2015 (JP) 2015-048158

(51) Int. Cl. G02C 7/10; G02B 1/04; C08F 2/44; C08F 220/12; C08F 218/14; C08K 5/13; G02C 7/02

(52) U.S. Cl. CPC G02C 7/10; G02B 1/041; C08F 2/44; C08L 31/00; C08F 218/14; C08K 5/13; G02C 7/02; C08F 220/12

(57) ABSTRACT

A plastic optical component with a high cutting ratio of blue light, and a method for producing the plastic optical component. The plastic optical component includes a benzophenone compound represented by formula (1) and an addition polymer obtained by radical polymerization of a monomer. The method for producing the plastic member includes a step of curing a mixture including the monomer, the benzophenone compound represented by formula (1), and a radical initiator.

PTL 2 describes a plastic lens including a specific benzophenone derivative in a plastic substrate as a plastic lens with little yellow coloring despite absorbing ultraviolet rays having a wavelength of around 400 nm.

PTL 3 describes an optical material including a specific benzotriazole ultraviolet absorber as an optical material that can provide a colorless optical material which is excellent in appearance and has a high blocking effect of blue light of about 420 nm.

### CITATION LIST

### Patent Literature

### [PTL 1] Japanese Patent Application Publication No. 2012-093689.

### [PTL 2] Japanese Patent No. 4117231.

### [PTL 3] WO 2014/133111.

### SUMMARY

### Technical Problem

When the specific benzophenone derivative described in PTL 2 is used, it is possible to obtain an optical component which exhibits a high cutting ratio of ultraviolet radiation with wavelengths in the vicinity of 400 nm, but also has a high cutting ratio of blue light on a longer wavelength side.

The specific benzotriazole compound described in PTL 3 is easily decomposed by radicals generated during radical polymerization of a monomer and when this compound is used in combination with an addition polymer obtained by radical polymerization of a monomer, the cutting ratio of blue light can decrease.

A problem of an embodiment of the present disclosure is to provide a plastic optical component having a high cutting ratio of blue light and a method for producing the same.

A problem of another embodiment of the present disclosure is to provide a plastic optical component having a high cutting ratio of blue light even when the plastic member includes an addition polymer obtained by radical polymerization of a monomer, and a method for producing the same.

### Solution to Problem

As a result of comprehensive research, the inventors of the present disclosure have found that the above-mentioned problems can be resolved by adding a benzophenone compound represented by formula (1) to a plastic optical component, and this finding led to the creation of the present disclosure.

Thus, the present disclosure provides the following [1] to [4].

[1] A plastic optical component comprising a benzophenone compound represented by the following formula (1) and an addition polymer obtained by radical polymerization of a monomer:

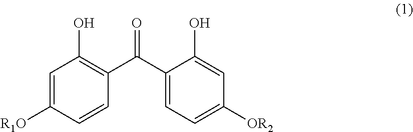

wherein, in formula (1), R₁ and R₂ each independently represent an alkyl group having 1 to 4 carbon atoms.

[2] A lens substrate comprising the optical component according to [1].

[3] A plastic lens having the lens substrate according to [2]. [4] A method for producing a plastic optical component, including:

curing a mixture including a monomer, a benzophenone compound represented by formula (1), and a radical initiator.

### Advantageous Effects of Invention

According to one embodiment of the present disclosure, it is possible to provide a plastic optical component having a high cutting ratio of blue light and a method for producing the same.

Further, according to the above-described embodiment, since the above-described benzophenone compound is unlikely to decompose during radical polymerization of a monomer, it is possible to provide an optical component having a high cutting ratio of blue light even when the member includes an addition polymer obtained by radical polymerization of a monomer, and a method for producing the optical component.

### DESCRIPTION OF EMBODIMENTS

[Optical Component]

### [Benzophenone Compound]

The plastic optical component of the present disclosure includes a benzophenone compound represented by the following formula (1) (hereinafter, also simply referred to as “benzophenone compound”),

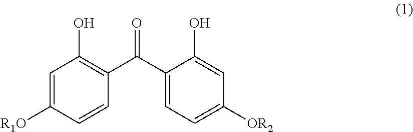

wherein, in formula (1), R₁ and R₂ each independently represent an alkyl group having 1 to 4 carbon atoms.

By using the benzophenone compound represented by formula (1), it is possible to obtain a plastic optical component excellent in absorbance of light in the blue region (380 nm to 500 nm). In addition, even when the optical component includes an addition polymer obtained by radical polymerization of a monomer, the benzophenone compound is unlikely to decompose even in the presence of radicals, and a high light absorbance of the obtained optical component in the blue region can be maintained.

The number of carbon atoms in the alkyl group of R₁ and R₂ may be 1 to 3, 1 or 2, and 1.

Examples of R₁ and R₂ include a methyl group, an ethyl group, an n-propyl group, an iso-propyl group, an n-butyl group, a sec-butyl group, an iso-butyl group, and a tert-butyl group. Among these, a methyl group and an ethyl group may have better, and a methyl group may have better.

Examples of the benzophenone compound include 2,2′-dihydroxy-4,4′-dimethoxybenzophenone, 2,2′-dihydroxy-4,4′-diethoxybenzophenone, 2,2′-dihydroxy-4,4′-di-n-propyloxybenzophenone, 2,2′-dihydroxy-4,4′-di-iso-propyloxybenzophenone, 2,2′-dihydroxy-4,4′-di-n-butyloxybenzophenone, 2,2′-dihydroxy-4,4′-di-sec-butyloxybenzophenone, 2,2′-dihydroxy-4,4′-di-iso-butyloxybenzophenone, and 2,2′-dihydroxy-4,4′-di-tert-butyloxybenzophenone.

Among them, the benzophenone compound may be 2,2′-dihydroxy-4,4′-dimethoxybenzophenone in order to increase the cutting ratio of blue light.

The content of the benzophenone compound may be 0.05 parts by mass or more, 0.5 parts by mass or more, and 1.0 parts by mass or more with respect to 100 parts by mass of the resin component forming the optical component in order to increase the cutting ratio of blue light. This content may be 3.0 parts by mass or less, 2.5 parts by mass or less, and 2.0 parts by mass or less with respect to 100 parts by mass of the resin component forming the optical component in order to increase the cutting ratio of blue light.

[Addition Polymer]

The optical component of the present disclosure may include an addition polymer obtained by radical polymerization of a monomer. The addition polymer may be a matrix of the optical component.

Since the benzophenone compound is unlikely to decompose during radical polymerization of a monomer, it is possible to obtain an optical component having a high cutting ratio of blue light even when the optical component includes the addition polymer obtained by radical polymerization of a monomer.

The content of the addition polymer in the optical component may be 60% by mass or more, 70% by mass or more, 80% by mass or more, and for example, 100% by mass or less, and 99% by mass or less.

In order to obtain a three-dimensionally crosslinked optical resin, it may have better that the monomer have two or more polymerizable unsaturated bonds in a molecule.

Examples of the polymerizable unsaturated bonds include a (meth)acrylate group, an allyl group, a vinyl group and the like. The (meth)acrylate group is at least one selected from a methacrylate group and an acrylate group.

Among these, at least one selected from a methacrylate group and an allyl group may have better.

As the monomer having two or more polymerizable unsaturated bonds in a molecule, it may have better that diethylene glycol bis-allyl carbonate be included, and it may have better that diethylene glycol bis-allyl carbonate, benzyl methacrylate, diallyl phthalate, and an alkyl methacrylatethe with an alkyl group having 1 to 4 carbon atoms be included.

The compounding amount of diethylene glycol bis-allyl carbonate may be 5% by mass or more, 10% by mass or more, 20% by mass or more, and 100% by mass or less, 80% by mass or less, 50% by mass or less, and 40% by mass or less with respect to the total amount of the monomer.

Further, when diethylene glycol bis-allyl carbonate is used in combination with benzyl methacrylate, diallyl phthalate, and an alkyl methacrylate with an alkyl group having 1 to 4 carbon atoms, from the viewpoint of prevention of cloudiness and striae generated during the production process, it may have better that the compounding amount of diethylene glycol bis-allyl carbonate may be 5 mass % or more, 10 mass % or more, 20 mass % or more, and 40% by mass or less, and 35% by mass or less with respect to the total amount of the monomer.

In order to prevent cloudiness and striae generated during the production process and to prevent yellowing, the compounding amount of benzyl methacrylate may be 5% by mass or more, 10% by mass or more, and 15% by mass or more, and 40% by mass or less, 30% by mass or less, and 25% by mass or less with respect to the total amount of the monomer.

Diallyl phthalate can be exemplified by one or two selected from the group consisting of diallyl isophthalate and diallyl terephthalate.

In order to improve formability and increase the refractive index, the compounding amount of the diallyl phthalate may be 14% by mass or more, 20% by mass or more, and 30% by mass or more, and 88% by mass or less, 70% by mass or less, and 60% by mass or less with respect to the total amount of the monomer.

Examples of the alkyl methacrylate with an alkyl group having 1 to 4 carbon atoms include at least one selected from the group consisting of methyl methacrylate, ethyl methacrylate, n-propyl methacrylate, isopropyl methacrylate, n-butyl methacrylate, sec-butyl methacrylate, isobutyl methacrylate, and tert-butyl methacrylate.

In order to improve releasability and moldability, the compounding amount of the alkyl methacrylate may be 1% by mass or more, 2% by mass or more, and 3% by mass or more, and 6 mass % or less and 5 mass % or less with respect to the total amount of the monomer.

[Other Polymer]

Examples of resin components for forming the plastic optical component of the present disclosure, other than the addition polymer, include a (thio)urethane resin, an episulfide resin, a polycarbonate resin, a polyamide resin, a polyester resin and the like.

((Thio)urethane Resin)

In the present disclosure, the monomer for forming the (thio)urethane resin is the monomer for preparing a polythiourethane lens or a polyurethane lens, specific examples thereof being obtained from a combination of a polyisocyanate compound and a polythiol compound or from a combination of a polyisocyanate compound and a polyol compound.

Examples of the polyisocyanate compounds include: alicyclic isocyanate compounds such as bis(isocyanatomethyl)cyclohexane, bis(isocyanatomethyl)bicyclo [2.2.1] heptane, hydrogenated 2,6-tolylene diisocyanate, hydrogenated meta- and para-phenylene diisocyanate, hydrogenated 2,4-tolylene diisocyanate, hydrogenated diphenylmethane diisocyanate, hydrogenated metaxylylene diisocyanate, hydrogenated paraxylylene diisocyanate, isophorone diisocyanate and the like; isocyanate compounds having no alicyclic or aromatic ring, such as meta- and para-phenylene diisocyanate, 2,6-tolylene diisocyanate, 2,4-tolylene diisocyanate, 4,4′-diphenylmethane diisocyanate, meta- and para-xylylene diisocyanato[bis(isocyanatomethyl)benzene], meta- and para-tetramethylxylylene diisocyanate, 2,6-naphthalene diisocyanate, 1,5-naphthalene diisocyanate, hexamethylene diisocyanate, octamethylene diisocyanate, 2,2,4-trimethylhexamethylene diisocyanate, tetramethylene diisocyanate, biuret reaction product of hexamethylene diisocyanate, trimer of hexamethylene diisocyanate, lysine diisocyanate, lysine triisocyanate, 1,6,11-undecane triisocyanate, triphenylmethane triisocyanate and the like; and sulfur-containing isocyanate compounds such as diphenyl disulfide-4,4′-diisocyanate, 2,2′-dimethyldiphenyl disulfide-5,5′-diisocyanate, 3,3′-dimethyldiphenyl disulfide-5,5′-diisocyanate, 3,3′-dimethyldiphenyl disulfide-6,6′-diisocyanate, 4,4′-dimethyldiphenyl disulfide-5,5′-diisocyanate, 3,3′-dimethoxydiphenyl disulfide-4,4′-diisocyanate, 4,4′-dimethoxydiphenyl disulfide-3,3′-diisocyanate, diphenylsulfone-4,4′-diisocyanate, diphenylsulfone-3,3′-diisocyanate, benzylidenesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanatodibenzylsulfone, 4,4′-dimethyldiphenylsulfone-3,3′-diisocyanate, 4,4′-di-tert-butyldiphenylsulfone-3,3′-diisocyanate, 4,4′-dimethoxybenzene ethylene disulfone-3,3′-diisocyanate, 4,4′-dichlorodiphenylsulfone-3,3′-diisocyanate, 4-methyl-3-isocyanatobenzenesulfonyl-4′-isocyanatophenol ester, 4-methoxy-3-isocyanatobenzenesulfonyl-4′-isocyanatophenol ester, 4-methyl-3-isocyanatobenzenesulfonylanilide-3′-methyl-4′-isocyanate, dibenzenesulfonyl-ethylenediamine-4,4′-diisocyanate, 4,4′-dimethoxybenzenesulfonyl-ethylenediamine-3,3′-diisocyanate, 4-methyl-3-isocyanatobenzenesulfonylanilide-4-methyl-3′-isocyanate, thiophene-2,5-diisocyanate, thiophene-2,5-diisocyanatomethyl, 1,4-dithiane-2,5-diisocyanate, 1,4-dithiane-2,5-diisocyanatomethyl, 1,4-dithiane-2,3-diisocyanatomethyl, 1,4-dithiane-2-isocyanatomethyl-5-isocyanatopropyl, 1,3-dithiolane-4,5-diisocyanate, 1,3-dithiolane-4,5-diisocyanatomethyl, 1,3-dithiolane-2-methyl-4,5-diisocyanatomethyl, 1,3-dithiolane-2,2-diisocyanatoethyl, tetrahydrothiophene-2,5-diisocyanate, tetrahydrothiophene-2,5-diisocyanatomethyl, tetrahydrothiophene-2,5-diisocyanatoethyl, tetrahydrothiophene-3,4-diisocyanatomethyl and the like. Among them, alicyclic isocyanate compounds may have better.

Examples of the polythiol compound include aliphatic thiols such as methanedithiol, 1,2-ethanedithiol, 1,1-propanedithiol, 1,2-propanedithiol, 1,3-propanedithiol, 2,2-propanedithiol, 1,6-hexanedithiol, 1,2,3-propanetrithiol, tetrakis(mercaptomethyl)methane, 1,1-cyclohexanedithiol, 1,2-cyclohexanedithiol, 2,2-dimethylpropane-1,3-dithiol, 3,4-dimethoxybutane-1,2-dithiol, 2-methylcyclohexane-2,3-dithiol, 1,1-bis(mercaptomethyl)cyclohexane, thiomalic acid bis(2-mercaptoethyl ester), 2,3-dimercaptosuccinic acid (2-mercaptoethyl ester), 2,3-dimercapto-1-propanol (2-mercaptoacetate), 2,3-dimercapto-1-propanol (3-mercaptoacetate), diethylene glycol bis(2-mercaptoacetate), diethylene glycol bis(3-mercaptopropionate), 1,2-dimercaptopropyl methyl ether, 2,3-dimercaptopropyl methyl ether, 2,2-bis(mercaptomethyl)-1,3-propanedithiol, bis(2-mercaptoethyl) ether, ethylene glycol bis(2-mercaptoacetate), ethylene glycol bis(3-mercaptopropionate), trimethylolpropane tris(2-mercaptoacetate), trimethylolpropane tris(3-mercaptopropionate), pentaerythritol tetrakis(2-mercaptoacetate), pentaerythritol tetrakis(3-mercaptopropionate), 1,2-bis(2-mercaptoethylthio)-3-mercaptopropane and the like; aromatic thiols such as 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,3-bis(mercaptoethyl)benzene, 1,4-bis(mercaptoethyl)benzene, 1,2-bis(mercaptomethoxy)benzene, 1,3-bis(mercaptomethoxy)benzene, 1,4-bis(mercapto methoxy)benzene, 1,2-bis(mercaptoethoxy)benzene, 1,3-bis(mercaptoethoxy)benzene, 1,4-bis(mercaptoethoxy)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,2,4-tris(mercaptoethyl)benzene, 1,3,5-tris(mercaptoethyl)benzene, 1,2,3-tris(mercaptomethoxy)benzene, 1,2,4-tris(mercaptomethoxy)benzene, 1,3,5-tris(mercaptomethoxy)benzene, 1,2,3-tris(mercaptoethoxy)benzene, 1,2,4-tris(mercaptoethoxy)benzene, 1,3,5-tris(mercaptoethoxy)benzene, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 1,2,3,4-tetrakis(mercaptoethyl)benzene, 1,2,3,5-tetrakis(mercaptomethoxy)benzene, 1,2,4,5-tetrakis(mercaptomethoxy)benzene, 1,2,3,4-tetrakis(mercaptoethoxy)benzene, 1,2,3,5-tetrakis(mercaptoethoxy)benzene, 1,2,4,5-tetrakis(mercaptoethoxy)benzene, 2,2′-dimercaptobiphenyl, 4,4′-dimercaptobiphenyl, 4,4′-dimercaptobibenzyl, 2,5-toluenedithiol, 3,4-toluenedithiol, 1,4-naphthalenedithiol, 1,5-naphthalenedithiol, 2,6-naphthalenedithiol, 2,7-naphthalenedithiol, 2,4-dimethylbenzene-1,3-dithiol, 4,5-dimethylbenzene-1,3-dithiol, 9,10-anthracenedimethanethiol, 1,3-di(p-methoxyphenyl)propane-2,2-dithiol, 1,3-diphenylpropane-2,2-dithiol, phenylmethane-1,1-dithiol, 2,4-di(p-mercaptophenyl) pentane and the like; halogen-substituted (chlorine-substituted, bromine-substituted, and the like) aromatic thiols such as 2,5-dichlorobenzene-1,3-dithiol, 1,3-di(p-chlorophenyl)propane-2,2-dithiol, 3,4,5-tribromo-1,2-dimercaptobenzene, 2,3,4,6-tetrachloro-1,5-bis(mercaptomethyl)benzene and the like; aromatic thiols including a sulfur atom in addition to a mercapto group, such as 1,2-bis(mercaptomethylthio)benzene, 1,3-bis(mercaptomethylthio)benzene, 1,4-bis(mercaptomethylthio)benzene, 1,2-bis(mercaptoethylthio)benzene, 1,3-bis(mercaptoethylthio)benzene, 1,4-bis(mercaptoethylthio)benzene, 1,2,3-tris(mercaptomethylthio)benzene, 1,2,4-tris(mercaptomethylthio)benzene, 1,3,5-tris(mercaptomethylthio)benzene, 1,2,3-tris(mercaptoethylthio)benzene, 1,2,4-tris(mercaptoethylthio)benzene, 1,3,5-tris(mercaptoethylthio)benzene, 1,2,3,4-tetrakis(mercaptomethylthio)benzene, 1,2,3,5-tetrakis(mercaptomethylthio)benzene, 1,2,4,5-tetrakis(mercaptomethylthio)benzene, 1,2,3,4-tetrakis(mercaptoethylthio)benzene, 1,2,3,5-tetrakis(mercaptoethylthio)benzene, 1,2,4,5-tetrakis(mercaptoethylthio)benzene and the like, and nuclear alkylated products thereof; aliphatic thiols containing a sulfur atom in addition to a mercapto group, such as bis(mercaptomethyl) sulfide, bis(mercaptoethyl) sulfide, bis(mercaptopropyl) sulfide, bis(mercaptomethylthio)methane, bis(2-mercaptoethylthio)methane, bis(3-mercaptopropylthio)methane 1,2-bis(2-mercaptomethylthio)ethane, 1,2-bis(2-mercaptoethylthio)ethane, 1,2-bis(3-mercaptopropylthio)ethane, 1,3-bis(mercaptomethylthio)propane, 1,3-bis(2-mercaptoethylthio) propane, 1,3-bis(3-mercaptopropylthio)propane, 1,2-bis(2-mercaptoethylthio)-3-mercaptopropane, 2-mercaptoethylthio-1,3-propanedithiol, 1,2,3-tris(mercaptomethylthio)propane, 1,2,3-tris(2-mercaptoethylthio) propane, 1,2,3-tris(3-mercaptopropylthio)propane, tetrakis(mercaptomethylthiomethyl)methane, tetrakis(2-mercaptoethylthiomethyl)methane, tetrakis(3-mercaptopropylthiomethyl)methane, bis(2,3-dimercaptopropyl) sulfide, 2,5-dimercapto-1,4-dithiane, bis(mercaptomethyl) disulfide, bis(mercaptoethyl) disulfide, bis(mercaptopropyl) disulfide and the like, and thioglycolic acid and mercaptopropionic acid esters thereof, hydroxymethyl sulfide bis(2-mercaptoacetate), hydroxymethyl sulfide bis(3-mercaptopropionate), hydroxyethyl sulfide bis(2-mercaptoacetate), hydroxyethyl sulfide bis(3-mercaptopropionate), hydroxypropyl sulfide bis(2-mercaptoacetate), hydroxypropyl sulfide bis(3-mercaptopropionate), hydroxymethyl disulfide bis(2-mercaptoacetate), hydroxymethyl disulfide bis(3-mercaptopropionate), hydroxyethyl disulfide bis(2-mercaptoacetate), hydroxyethyl disulfide bis(3-mercaptopropionate), hydroxypropyl disulfide bis(2-mercaptoacetate), hydroxypropyl disulfide bis(3-mercaptopropionate), 2-mercaptoethyl ether bis(2-mercaptoacetate), 2-mercaptoethyl ether bis(3-mercaptopropionate), 1,4-dithiane-2,5-diol bis(2-mercaptoacetate), 1,4-dithiane-2,5-diol bis(3-mercaptopropionate), thioglycolic acid (2-mercaptoethyl ester), thiodipropionic acid bis(2-mercaptoethyl ester), 4,4′-thiodibutyric acid bis(2-mercaptoethyl ester), dithiodiglycolic acid bis(2-mercaptoethyl ester), dithiodipropionic acid bis(2-mercaptoethyl ester), 4,4′-dithiodibutyric acid bis(2-mercaptoethyl ester), thiodiglycolic acid bis(2,3-dimercaptopropyl propyl ester), thiodipropionic acid bis(2,3-dimercaptopropyl ester), dithiodiglycolic acid bis(2,3-dimercaptopropyl ester), dithiodipropionic acid bis(2,3-dimercaptopropyl ester), 4-mercaptomethyl-3,6-dithiaoctane-1,8-dithiol, bis(mercaptomethyl)-3,6,9-trithia-1,11-undecane dithiol, bis(1,3-dimercapto-2-propyl) sulfide, and the like; and heterocyclic compounds including a sulfur atom in addition to a mercapto group such as 3,4-thiophenedithiol, tetrahydrothiophene-2,5-dimercaptomethyl, 2,5-dimercapto-1,3,4-thiadiazole, 2,5-dimercapto-1,4-dithiane, 2,5-dimercaptomethyl-1,4-dithiane and the like.

Examples of the polyol compounds include aliphatic polyols such as ethylene glycol, diethylene glycol, propylene glycol, dipropylene glycol, butylene glycol, neopentyl glycol, glycerin, trimethylolethane, trimethylolpropane, butanetriol, 1,2-methyl glucoside, pentaerythritol, dipentaerythritol, tripentaerythritol, triethylene glycol, polyethylene glycol, tris(2-hydroxyethyl) isocyanurate, cyclobutanediol, cyclopentanediol, cyclohexanediol, cycloheptanediol, cyclooctanediol, bicyclo [4.3.0]-nonanediol, dicyclohexanediol, tricyclo [5.3.1.1] dodecanediol, spiro [3.4] octanediol, butylcyclohexanediol and the like; aromatic polyols such as dihydroxynaphthalene, trihydroxynaphthalene, tetrahydroxynaphthalene, dihydroxybenzene, benzenetriol, trihydroxyphenanthrene, bisphenol A, bisphenol F, xylylene glycol, tetrabromobisphenol A and the like, and products of addition reaction thereof with alkylene oxides such as ethylene oxide, propylene oxide and the like; bis-[4-(hydroxyethoxy)phenyl] sulfide, bis-[4-(2-hydroxypropoxy) phenyl] sulfide, bis-[4-(2,3-dihydroxypropoxy)phenyl] sulfide, bis-[4-(4-hydroxycyclohexyloxy)phenyl] sulfide, bis-[2-methyl-4-(hydroxyethoxy)-6-butylphenyl] sulfide and compounds obtained by adding an average of 3 molecules or less of ethylene oxide and/or propylene oxide per one hydroxyl group to these compounds; and polyols including a sulfur atom, such as di-(2-hydroxyethyl) sulfide, 1,2-bis-(2-hydroxyethylmercapto)ethane, bis(2-hydroxyethyl) disulfide, 1,4-dithiane-2,5-diol, bis(2,3-dihydroxypropyl) sulfide, tetrakis(4-hydroxy-2-thiabutyl)methane, bis(4-hydroxyphenyl) sulfone (trade name BISPHENOL S), tetrabromobisphenol S, tetramethylbisphenol S, 4,4′-thiobis(6-tert-butyl-3-methylphenol), 1,3-bis(2-hydroxyethylthioethyl)cyclohexane and the like.

Further, in order to modify physical properties such as heat resistance and refractive index, it is also possible to add another monomer such as diethylene glycol allyl carbonate in addition to the monomer forming the episulfide resin which is described hereinbelow.

(Episulfide Resin)

In the present disclosure, a monomer forming an episulfide resin, which is also referred to as a monomer forming an epithio structure, designates a monomer having an episulfide group (epithio group) or a mixed monomer including such a monomer. Examples of the monomers having an episulfide group include episulfide compounds having an alicyclic skeleton such as 1,3- and 1,4-bis(β-epithiopropylthio)cyclohexane, 1,3- and 1,4-bis(β-epithiopropylthiomethyl)cyclohexane, bis[4-(β-epithiopropylthio)cyclohexyl]methane, 2,2-bis[4-(β-epithiopropylthio)cyclohexyl]propane, bis[4-(β-epithiopropylthio)cyclohexyl] sulfide, and the like; episulfide compounds having an aromatic skeleton such as 1,3- and 1,4-bis(β-epithiopropylthio)benzene, 1,3- and 1,4-bis(β-epithiopropylthiomethyl)benzene, bis[4-(β-epithiopropylthio)phenyl]methane, 2,2-bis[4-(β-epithiopropylthio)phenyl]propane, bis[4-(β-epithiopropylthio)phenyl]sulfide, bis[4-(β-epithiopropylthio)phenyl]sulfine, 4,4-bis(β-epithiopropylthio)biphenyl and the like; episulfide compounds having a dithiane skeleton such as 2,5-bis(β-epithiopropylthiomethyl)-1,4-dithiane, 2,5-bis(β-epithiopropylthioethylthiomethyl)-1,4-dithiane, 2,5-bis(β-epithiopropylthioethyl)-1,4-dithiane, 2,3,5-tri(β-epithiopropylthioethyl)-1,4-dithiane, and the like; and episulfide compounds having an aliphatic skeleton such as 2-(2-β-epithiopropylthioethylthio)-1,3-bis(β-epithiopropylthio)propane, 1,2-bis[(2-β-epithiopropylthioethyl)thio]-3-(β-epithiopropylthio)propane, tetrakis(β-epithiopropylthiomethyl)methane, 1,1,1-tris(β-epithiopropylthiomethyl)propane, bis-(β-epithiopropyl) sulfide and the like.

In order to modify physical properties of a lens, such as impact resistance and processability, it is also possible to add another monomer for an optical component such as the monomer for forming the (thio)urethane resin which is described hereinabove.

Further, in the present disclosure, a diethylene glycol bis-allyl carbonate type monomer can be added to the monomer forming the (thio)urethane resin and/or the episulfide resin.

The diethylene glycol bis-allyl carbonate type monomer is diethylene glycol bis-allyl carbonate alone or a mixed monomer of diethylene glycol bis-allyl carbonate and a monomer copolymerizable therewith. Specific examples of the copolymerizable monomers include aromatic vinyl compounds such as styrene, α-methylstyrene, vinyltoluene, chlorostyrene, chloromethylstyrene, divinylbenzene and the like; mono(meth)acrylates such as methyl (meth)acrylate, n-butyl (meth) acrylate, n-hexyl (meth) acrylate, cyclohexyl (meth)acrylate, 2-ethylhexyl (meth)acrylate, methoxydiethylene glycol (meth)acrylate, methoxypolyethylene glycol (meth) acrylate, 3-chloro-2-hydroxypropyl (meth) acrylate, stearyl (meth)acrylate, lauryl (meth)acrylate, phenyl (meth)acrylate, glycidyl (meth)acrylate, benzyl methacrylate and the like; mono(meth)acrylates having a hydroxy group such as 2-hydroxyethyl (meth)acrylate, 2-hydroxypropyl (meth)acrylate, 3-hydroxypropyl (meth)acrylate, 3-phenoxy-2-hydroxypropyl (meth) acrylate, 4-hydroxybutyl (meth)acrylate and the like; di(meth)acrylates such as ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, neopentyl glycol di(meth)acrylate, polypropylene glycol di(meth)acrylate, 2-hydroxy-1,3-di(meth)acryloxylpropane, 2,2-bis[4-((meth)acryloxyethoxy)phenyl]propane, 2,2-bis[4-((meth)acryloxy-diethoxy)phenyl]propane, 2,2-bis[4-((meth)acryloxy-polyethoxy)phenyl]propane and the like; tri(meth)acrylates such as trimethylolpropane trimethacrylate, tetramethylolmethane trimethacrylate and the like; tetra(meth)acrylate such as tetramethylolmethane tera(meth)acrylate and the like ((meth)acrylate in the present description means methacrylate or acrylate); diallyl phthalate, diallyl isophthalate, diallyl terephthalate and the like.

When a monomer forming a thiourethane structure is used as a main component in the plastic optical component of the present disclosure, polymerization is performed from starting materials in which the total mass of the polyisocyanate compound and the polythiol compound may be 60 parts by mass or more, 80 parts by mass or more, and 90 parts by mass or more with respect to 100 parts by mass of the total amount of the monomer.

Further, when a monomer forming an episulfide resin is used as a main component, polymerization is performed from starting materials in which the amount of the compound having an episulfide group may be 60 parts by mass or more, 80 parts by mass or more, and 90 parts by mass or more with respect to 100 parts by mass of the total amount of the monomer.

[Production Method]

The method for producing an optical component may include a step of curing a mixture including a monomer, a benzophenone compound represented by formula (1), and a radical initiator.

The step of curing may be carried out by casting the mixture into a mold for a lens assembled of a glass or a metal mold and a resin gasket or a tape, and polymerizing and curing the monomer by heating or ultraviolet irradiation. The mold for the lens may be assembled of a glass mold and a resin gasket or a tape.

Examples of the radical initiator include 1,1-azobiscyclohexane carbonate, diisopropyl peroxycarbonate, 1,1′-azobiscyclohexane nitrate, di-tert-butyl peroxide and the like.

The compounded amount of the radical initiator may be 0.1 parts by mass or more, 0.5 parts by mass or more, 1.0 parts by mass or more and 10 parts by mass or less, 8 parts by mass or less, and 5 parts by mass or less with respect to 100 parts by mass of the monomer.

Where the resin component forming the optical component of the present disclosure is other than the addition polymer described above, a method for producing the optical component can involve adding one or more kinds of benzophenones selected from the group consisting of the benzophenone compounds represented by formula (1), for example, to a monomer that forms the (thio)urethane resin and/or episulfide resin, mixing, and then polymerizing the monomer. The polymerization method of the monomer is not particularly limited, but cast polymerization is usually used. Thus, an optical component is obtained by mixing one or more benzophenol compounds selected from the group consisting of the benzophenone compounds represented by formula (1) with the above-mentioned monomer, casting the liquid mixture into a lens mold, and heating usually between −20° C. and 150° C.

In addition, auxiliary agents such as an internal release agent, an antioxidant, a fluorescent whitening agent, a bluing agent and the like can be added as required. Further, the optical component of the present disclosure can be subjected to dyeing treatment by using a colorant.

[Structure of Optical Component]

The plastic optical component of the present disclosure may be a lens substrate or a functional layer, but in order to increase the cutting ratio of blue light with a small content, it may be a lens substrate or a spectacle lens substrate.

The plastic optical component of the present disclosure may be a plastic lens having a lens substrate, a plastic lens having a lens substrate and a functional layer provided on the lens substrate. The plastic lens may be a plastic lens for spectacles.

The functional layer may be exemplified by at least one selected from a cured film, a primer layer, an antireflection film and a water-repellent film.

The cured film is provided for improving the scratch resistance and may be formed by coating a coating liquid having a fine particulate inorganic substance such as an organosilicon compound, tin oxide, silicon oxide, zirconium oxide, titanium oxide or the like.

The primer layer is provided for improving impact resistance and includes, for example, polyurethane as a main component. Here, the polyurethane content in the primer layer may be 50% by mass or more.

The antireflection film can be obtained by laminating silicon oxide, titanium dioxide, zirconium oxide, tantalum oxide or the like.

The water repellent film can be formed using an organosilicon compound having a fluorine atom.

In the plastic optical component of the present disclosure, the site containing the benzophenone compound represented by formula (1) is not particularly limited, and the benzophenone compound may be included in the functional layer or the lens substrate. More specifically, the benzophenone compound may be contained in any of the lens substrate, the cured film, the primer layer, the antireflection film, and the water-repellent film, but may be included in the lens substrate.

A plastic optical component in which a benzophenone compound is included in a functional layer can be produced by preparing a composition in which the benzophenone compound, the resin component and, if necessary, a solvent or the like are mixed, coating the composition at least on one surface of the lens substrate and curing to form a functional layer.

When the plastic optical component of the present disclosure is used as a lens substrate, the refractive index of the lens substrate is not particularly limited, but is 1.50 or more and 1.60 or less.

The light cutting ratio of the plastic optical component of the present disclosure in the blue region of 380 nm to 500 nm may be 35% or more, and 40% or more, in order to protect the eyes. The light cutting ratio is not particularly limited, but may be 60% or less, and 50% or less.

The cutting ratio of the plastic optical component of the present disclosure with respect to light having a wavelength of 410 nm may be 50% or more, and 60% or more.

The plastic optical component of the present disclosure may be transparent. In the present description, “transparent” means that the far side is visible through the member.

Light transmittance of the optical component of the present disclosure in a wavelength range of 400 nm to 700 nm may be 70% or more, 80% or more, and 90% or more to ensure transparency of the optical element.

In the present disclosure, matters described as examples or preferred ranges in the detailed description of the disclosure may be arbitrarily combined with respect to the examples, contents, and physical properties of each of the above-mentioned components.

Further, where the composition described in the detailed description of the disclosure is adjusted to the composition described in the examples, the disclosed embodiments can be carried out in the same manner as in the examples over the entire composition range claimed.

### EXAMPLES

The present disclosure will be specifically described hereinbelow by way of examples, but the present disclosure is not limited to these examples. Further, the plastic optical component is exemplified by a plastic lens. Physical properties of the produced plastic lens were obtained by the following methods.

(1) Measurement of Light Ray Cutting Ratio in the Blue Region (Wavelength Region of 380 nm to 500 nm) (Hereinafter Also Referred to as “Blue Light Cutting Ratio”)

The transmittance at a wavelength of 380 nm to 500 nm was measured with a spectrophotometer (U-4100, Hitachi, Ltd.), and the blue light cutting ratio was calculated by the following formula from the transmittance (T) (13 points) for every 10 nm between the wavelengths.

$$Blue light cutting ratio = 100 - \frac{{\sum }_{380 nm}^{500 nm} ( T )}{13} \qquad [ Math . 1 ]$$

(2) Measurement of Light Cutting Ratio at the Wavelength of 410 nm

The light transmittance at a wavelength of 410 nm was measured using the spectrophotometer, and the light cutting ratio was calculated by the following formula.

Light cutting ratio (%)=100−(transmittance at 410 nm)

(3) Measurement of Light Transmittance in the Wavelength Range of 400 nm to 700 nm

The transmittance at a wavelength of 400 nm to 700 nm was measured using the spectrophotometer (U-4100, manufactured by Hitachi, Ltd.).

### Example 1

A total of 1.0 parts by mass of 2,2′-dihydroxy-4,4′-dimethoxy benzophenone was added to 30 parts by mass of diethylene glycol bis(allyl carbonate) (hereinafter, also referred to as “DEGBAC”), 20 parts by mass of benzyl methacrylate (hereinafter, also referred to as “BzMA”), 45 parts by mass of diallyl isophthalate (hereinafter also referred to as “DRIP”), and 5 parts by mass of methyl methacrylate (hereinafter also referred to as “MMA”) as monomers, and then 3 parts by mass of diisopropyl peroxycarbonate as a radical initiator was added to prepare a mixture. No release agent was added to the mixture.

Next, the mixture was cast into a mold composed of two glass molds and a resin gasket. The temperature was then raised from 40° C. to 90° C. over 24 hours to polymerize the monomers. After heating and polymerization, the mold was immersed in a methylene chloride-alkali mixed washing solution after only the gasket was removed therefrom, and then a plastic lens made of the cured copolymer was removed from the mold and further heat-treated for 1 hours at 120° C.

The obtained plastic lens had a refractive index (nD) of 1.55 and a light transmittance of 91% in a wavelength region of 400 nm to 700 nm.

### Example 2

A plastic lens was obtained under the same conditions as in Example 1, except that “30 parts by mass of diethylene glycol bis(allyl carbonate), 20 parts by mass of benzyl methacrylate, 45 parts by mass of diallyl isophthalate and 5 parts by mass of methyl methacrylate” were replaced with “100 parts by mass of DEGBAC”.

The obtained plastic lens had a refractive index (nD) of 1.55 and a light transmittance of 91% in a wavelength region of 400 nm to 700 nm.

### Comparative Example 1

A plastic lens was obtained under the same conditions as in Example 1, except that “2,2′-dihydroxy-4,4′-dimethoxy benzophenone” was replaced with “2,2′-dihydroxy-4-octyloxy benzophenone”.

TABLE 1

| | | | Light | Light | |
|---|---|---|---|---|---|
| | | | cutting | cutting | Light |
| | | | ratio | ratio | transmittance |
| | | | in blue | at 410 | in 400 nm to |
| | Compound | Polymer | region | nm | 700 nm range |
| Example 1 | 1-1 | 2-1 | 41% | 95% | 91% |
| Example 2 | 1-1 | 2-2 | 41% | 95% | 91% |
| Comparative | C1-1 | 2-1 | 21% | 15% | 91% |
| Example 1 | | | | | |

The meaning of various symbols in the table is explained below.

Compound 1-1: 2,2′-dihydroxy-4,4′-dimethoxybenzophenone
Compound C1-1: 2,2′-dihydroxy-4-octyloxybenzophenone
Polymer 2-1: polymer of 30 parts by mass of DEGBAC, 20 parts by mass of BzMA, 45 parts by mass of DAIP and 5 parts by mass of MMA
Polymer 2-2: polymer of DEGBAC

Finally, an embodiment of the present disclosure is summarized.

One embodiment of the present disclosure is

a plastic optical component including a benzophenone compound represented by the following formula (1):

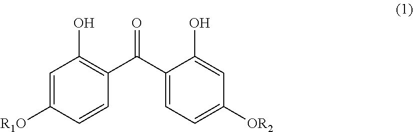

wherein, in formula (1), R₁ and R₂ each independently represent an alkyl group having 1 to 4 carbon atoms.

The optical component of the present disclosure has a high cutting ratio of blue light.

The optical component of the present disclosure may include an addition polymer obtained by radical polymerization of a monomer.

One embodiment of the present disclosure is a method for producing a plastic optical component including a step of curing a mixture including a monomer, a benzophenone compound represented by formula (1), and a radical initiator.

Since the above-described benzophenone compound is unlikely to decompose during radical polymerization of a monomer, it is possible to provide an optical component having a high cutting ratio of blue light even when the member includes an addition polymer obtained by radical polymerization of a monomer.

### INDUSTRIAL APPLICABILITY

According to the present disclosure, it is possible to provide a plastic optical component having a high cutting ratio of blue light and a method for producing the optical component which can be used, for example, for a spectacle lens.

1. A plastic optical component comprising a benzophenone compound represented by the following formula (1) and an addition polymer obtained by radical polymerization of a monomer: 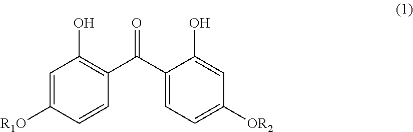
wherein, in formula (1), R₁ and R₂ each independently represent an alkyl group having 1 to 4 carbon atoms.

2. The optical component according to claim 1, wherein the benzophenone compound is 2,2′-dihydroxy-4,4′-dimethoxybenzophenone.

3. The optical component according to claim 1, wherein the benzophenone compound is comprised in an amount of 0.05 parts by mass to 3.0 parts by mass with respect to 100 parts by mass of a resin component forming the optical component.

4. The optical component according to claim 1, wherein a light cutting ratio in a wavelength region of 380 nm to 500 nm is 35% or more.

5. The optical component according to claim 1, wherein a cutting ratio of light having a wavelength of 410 nm is 50% or more.

6. The optical component according to claim 1, wherein the monomer includes a monomer having two or more polymerizable unsaturated bonds in a molecule.

7. The optical component according to claim 1, wherein the monomer includes diethylene glycol bis-allyl carbonate.

8. The optical component according to claim 1, wherein the monomer includes diethylene glycol bis-allyl carbonate, benzyl methacrylate, diallyl phthalate and alkyl methacrylate having an alkyl group having 1 to 4 carbon atoms.

9. A lens substrate comprising the optical component according to claim 1.

10. A plastic lens having the lens substrate according to claim 9.

11. A method for producing a plastic optical component, comprising:
curing a mixture containing a monomer, a benzophenone compound represented by the following formula (1) and a radical initiator: 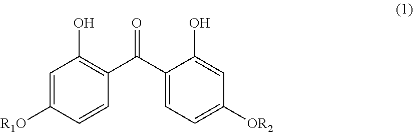
wherein, in formula (1), R₁ and R₂ each independently represent an alkyl group having 1 to 4 carbon atoms.
